(19) United States
(12) Patent Application Publication
(10) Pub. No.: US 2003/0151163 A1
(43) Pub. Date: Aug. 14, 2003

(54) Apparatus and method for forming a mold

(76) Inventor: Martin Pelletier, Loretteville (CA)

Correspondence Address: MR. S. PETER LUDWIG, DARBY & DARBY P.C., 805 THIRD AVENUE, NEWYORK, NY, 10022, US

(21) Appl. No.: 10/076,916

(22) Filed: Feb. 14, 2002

(51) Int. Cl. B29C 33/40

(52) U.S. Cl. 264/219; 425/175

(57) ABSTRACT

An apparatus and process for manufacturing a mold with a reusable material. The apparatus having a heating basin, a pump for pumping the liquefied heat sensitive pliable substance out from the heating basin and into a cooler. The heat sensitive pliable substance is injected in a forming tool according to a definite path in order to form a mould.

### FIELD OF THE INVENTION

The present invention relates to an apparatus and a process for manufacturing a mold,

### BACKGROUND OF THE INVENTION

Molds having different shape and size exist for moulding different pieces of various composite materials. Each of these molds is used for molding a piece of composite material in a unique shape and size. They may not be reused for molding a piece of another shape and size. Therefore, there is a need to produce different types of molds for different required dimensions The main inconvenience with such a molding process is related to the high cost of the material needed to carry out the process and the time that is needed to prepare such material.

U.S. Pat. No. 4,929,403 is concerned with a process for forming a flexible mold for finely detailed objects from a radiatively curable molding composition. The molding composition includes coating at least a portion of the surface of a three-dimensional object. The coating is cured by exposing the fluid coating to radiative energy to form an elastic, flexible layer of cured molding composition on the object.

Therefor there is a need to provide a simple apparatus and process for manufacturing a mold with a reusable material.

### SUMMARY OF THE INVENTION

An object of the present invention is to provide an apparatus and method for manufacturing a mold.

Another object of the present invention is to provide an apparatus and method for manufacturing a mold with a reusable material.

In accordance with the present invention, these objects are achieved with an apparatus for manufacturing a mold, the apparatus comprising:

a heating basin for liquefying and maintaining a heat sensitive pliable substance in a liquid form;

a pump for pumping out from the heating basin the liquefied heat sensitive pliable substance;

a cooler for receiving and cooling the heat sensitive pliable substance pumped out of the heating basin to a predetermined texture;

an applicator for ejecting the heat sensitive pliable substance out from the apparatus and into a forming tool; and

a positioning system for moving the applicator and for building a mold by successive application of a formed thread of heat sensitive pliable substance.

Also in accordance with the present invention, there is provided a process for producing a mold with a reusable material, the process comprising the steps of:

a) selecting a heat sensitive pliable substance,

b) liquefying the heat sensitive pliable substance to obtain a liquid substance,

c) cooling the liquid substance to obtain a semi-rigid substance, and

d) applying the semi-rigid substance obtained in step c) with a forming tool so as to allow the heat sensitive pliable substance to harden into a definite shape and thereby form a mold.

An advantage provided by the apparatus and method of the present invention is that it allows the manufacture of molds in a wide variety of shape and sizes with the same amount of molding material. This in turn, significantly reduces the cost of mould manufacture.

Another advantage of using a heat sensitive pliable substance as the base for the mold is that it is possible to create, with the same load of substance, various sets of moulds having different shapes and sizes in little time. Furthermore, since the substance may be reused to form other moulds, little waste is generated.

Furthermore, the process of the present invention allows the manufacture of a small number of reinforced plastic pieces (1 to 5) in a short time and at very low cost,

The present invention and its advantages will be more easily understood after reading the following non-restrictive description of preferred embodiments thereof, made with reference to the hereinbelow drawings.

### BRIEF DESCRIPTION OF THE DRAWINGS

FIG. 1 is a general overview of the apparatus according to a preferred embodiment of the present invention.

FIG. 2 is a side view of a portion of the apparatus of FIG. 1.

FIG. 3 is a schematic representation of the path along which the heat sensitive pliable substance is applied from the apparatus of FIG. 1

FIG. 4 is a schematic representation of a forming tool.

### DETAILED DESCRIPTION OF THE INVENTION

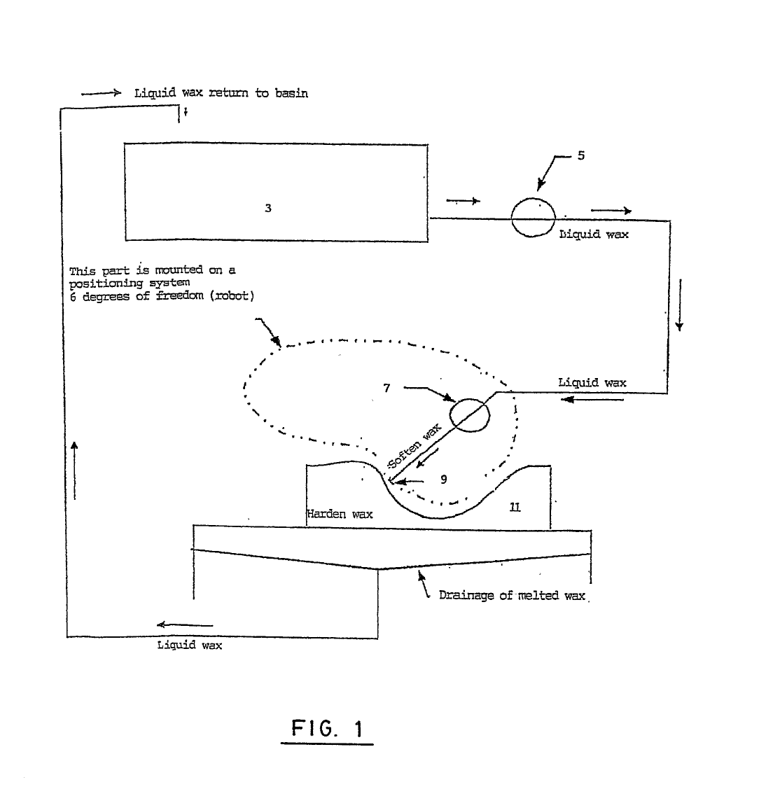

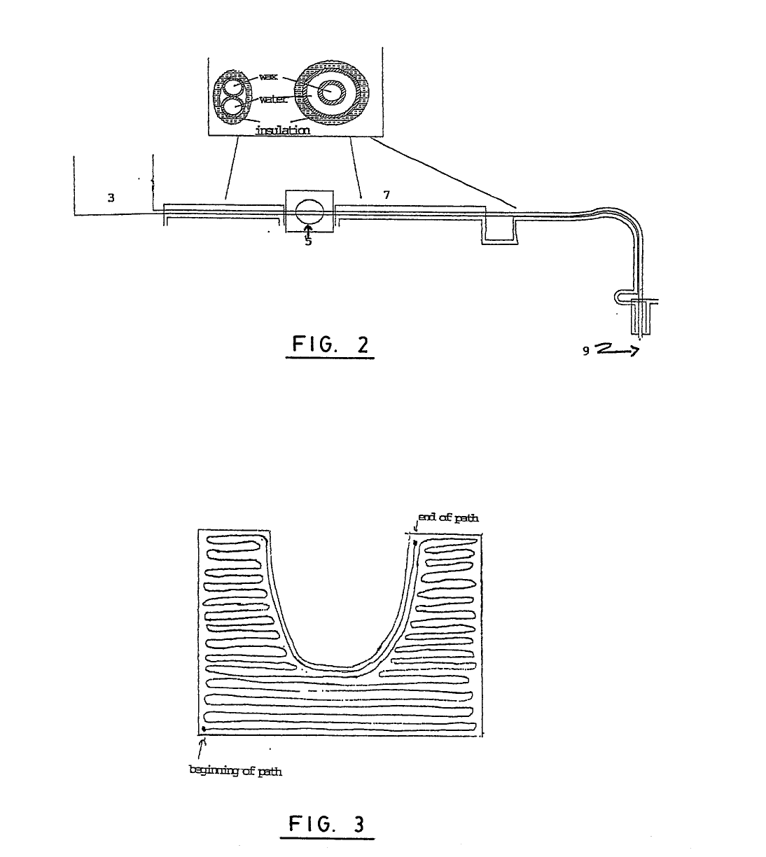

As seen in FIG. 1, the present invention relates to an apparatus for manufacturing a mold with a reusable material. The apparatus comprises a heating basin 3; a pump 5; a cooler 7; and an applicator 9, The heating basin 3 is designed to liquefy and maintain a heat sensitive pliable substance in a liquid form. The heating basin 3 may comprise a heat exchanger such as an electrical heating element or a hot fluid circulating system. It should be understood that any other heating devices suitable for use in the context of the present invention may be used.

The pump 5 is used to pump the liquefied heat sensitive pliable substance out from the heating basin 3 and into a cooler. According to a preferred embodiment, the pump 5 may further include a heating device. This heating device would help to maintain the heat sensitive pliable substance in an appropriate state, generally liquid, prior to reaching the cooler. In the context of the present invention, it is important that the heat-sensitive pliable substance does not solidify too quickly prior to reaching the cooler since it would cause obstruction of the apparatus.

The cooler 7 is designed for receiving and cooling the heat sensitive pliable substance pumped out of the heating basin 3 to a predetermined texture. The heat sensitive pliable substance is cooled down in order to reach a predetermined state that is between the liquid and solid state. In a preferred embodiment, the cooler 7 is in the shape of a longitudinal flexible tube, the tube having a diameter of less than 4 mm. Once the substance is cooled down and reaches the predetermined texture, it is pumped to the applicator 9. Again, any cooling device that may enable the cooling of the of the heat sensitive pliable substance may be used in the context of the present invention. For instance, the cooler may comprise a coil of tube submerged in a cooling fluid.

The applicator 9 may be mounted on a positioning system having 6 degrees of freedom.

The applicator 9 of the apparatus of the present invention ejects the heat sensitive pliable substance out from the apparatus and on the mould. The applicator 9 may be connected to a forming tool for projecting and directing and forming the heat sensitive pliable substance on the mold.

The heat sensitive pliable substance that may be used in the context of the present invention may be a substance selected from the group consisting of wax and any other malleable plastic.

The present invention also relates to a process for producing a mold with a reusable material. The process comprises the steps of;

a) selecting a heat sensitive pliable substance,

b) liquefying the heat sensitive pliable substance to obtain a liquid substance,

c) cooling the liquid substance to obtain a semi-rigid substance, and

d) applying the semi-rigid substance obtained in step c) with an applicator so as to allow the heat sensitive pliable substance to harden into a definite shape and thereby form a mold.

In a preferred embodiment, step d) comprises extruding the semi-rigid substance through a forming tool which may be a nozzle. The substance is extruded according to a definite path.

The process of the present invention may further comprise a step whereby the mold obtained in d) is melted in the heating basin for the manufacture of a new mold.

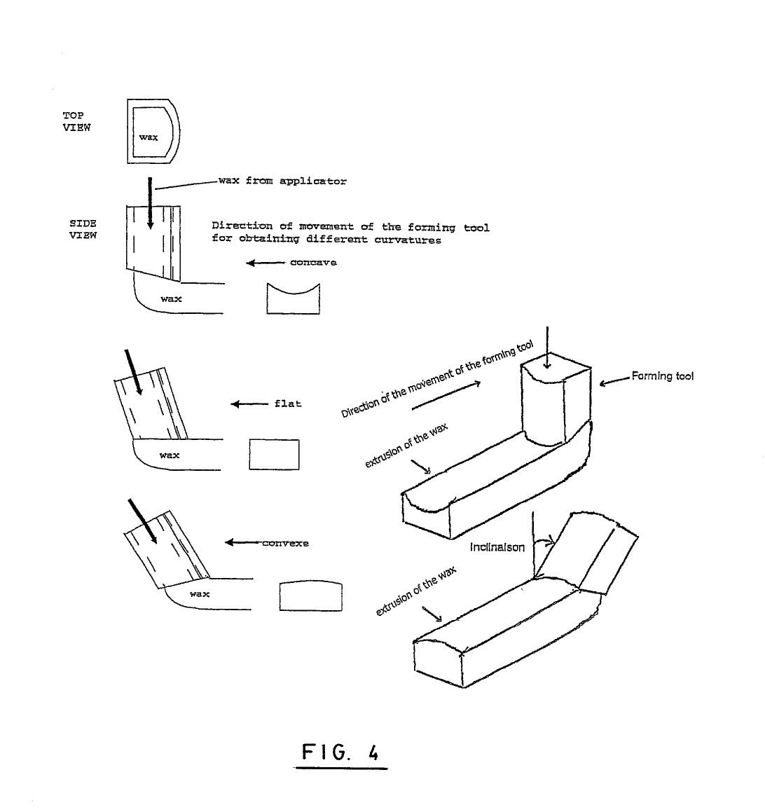

In use, the mould is produced by successive application of a formed thread of heat sensitive pliable substance according to a definite path. FIG. 3 show an example of a path to build a plane layer of a mold, A complete mold is produced by superposition of multiple layers. The thread is formed by the forming tool installed on the applicator. The forming tool is a specially shaped nozzle. The forming tool as shown in FIG. 4 allow to extrude thread with various curvature by modifying the angle relative to the direction of the movement of the applicator. As the substance is applied, it hardens into the shape of the mold.

As can be seen in FIG. 3, and the above description of the molding process is a simplified illustration of the actual process. Normally, the path is in three dimension.

The mold manufacture according to the present invention may be reused in order to form a new mold having a different shape and size. More precisely, the mold which is made of heat-sensitive pliable substance may be placed in the heating basin. It is then melted inside the heating basin. When the heat sensitive pliable substance reaches the liquid state, a new cycle for the manufacture of a new mold begins.

In an alternative embodiment, the mold can be melted outside of the heating basin and pumped into the basin.

Although the present invention has been explained hereinabove by way of a preferred embodiment thereof, it should be pointed out that any modifications to this preferred embodiment within the scope of the present invention is not deemed to alter or change the nature and scope of the present invention.

1. An apparatus for manufacturing a mold, the apparatus comprising:
a heating basin for liquefying and maintaining a heat sensitive pliable substance in a liquid form;
a pump for pumping out from the heating basin the liquefied heat sensitive pliable substance;
a cooler for receiving and cooling the heat sensitive pliable substance pumped out of the heating basin to a predetermined texture;
an applicator for ejecting the heat sensitive pliable substance out from the apparatus and into a forming tool; and
a positioning system for moving the applicator and for building a mold by successive application of a formed thread of heat sensitive pliable substance.

2. An apparatus according to claim 1, wherein the heat sensitive pliable substance is selected from the group consisting of wax and any other malleable plastic.

3. An apparatus according to claim 1, wherein the heating basin comprises a heat exchanger.

4. An apparatus according to claim 3, wherein the heat exchanger is an electrical heating element.

5. An apparatus according to claim 3, wherein the heat exchanger is a hot fluid circulating system.

6. An apparatus according to claim 1, wherein the pump further includes a heating device.

7. An apparatus according to claim 1, wherein the cooler is in the shape of a longitudinal flexible tube, the tube having a diameter of less than 4 mm.

8. An apparatus according to claim 1, wherein the cooler comprises a coil tube submerged in a cooling fluid.

9. An apparatus according to claim 1, wherein the applicator is connected to a forming tool for projecting and directing the heat sensitive pliable substance on the mold.

10. An apparatus according to claim 1, wherein the forming tool is a nozzle adapted to extrude various shape of thread by modifying the angle from the direction of the movement of the applicator.

11. A process for producing a heat sensitive pliable mold, the process comprising the steps of
a) selecting a heat sensitive pliable substance,
b) liquefying the heat sensitive pliable substance to obtain a liquid substance,
c) cooling the liquid substance to obtain a semi-rigid substance, and
d) applying the semi-rigid substance obtained in step c) with an applicator so as to allow the heat sensitive pliable substance to harden into a definite shape and thereby form a mold.

12. A process according to claim 11, further comprising the step of melting the mold obtained in d) in a heating basin for the manufacture of a new mold.

13. A process according to claim 11, further comprising the step of melting the mold outside the basin and pumping the liquid heat sensitive substance in the heating basin.

14. A process according to claim 11, wherein the molding step d) comprises extruding the semi-rigid substance through a forming tool.

15. A process according to claim 9, wherein the heat sensitive pliable substance is selected from the group consisting of wax and any other malleable plastic.

16. A process according to claim 14, wherein the forming tool is adapted to extrude thread with various curvature by modifying the angle from the direction of the movement of the applicator.

17. A process according to claim 11, wherein the molding step d) comprises moving the applicator along a three dimension path and applying the thread side by side and overcoating the path.
